(19) United States
(12) Patent Application Publication
(10) Pub. No.: US 2003/0090765 A1
(43) Pub. Date: May 15, 2003

(54) Free-space optical communication system

(76) Inventors: Brian W. Neff, Solana Beach, CA (US); Gerald R. Clark, San Diego, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/008,463

(22) Filed: Nov. 9, 2001

(51) Int. Cl. H04B 10/00

(52) U.S. Cl. 359/172; 359/159

(57) ABSTRACT

The present invention provides a method and apparatus for free space optical communication. The method and apparatus transmit a large diameter optical signal across a free space link to over fill a plurality of receive objectives. Each of receive objectives focus the portions of the impinging optical signal into a respective fiber optic core, where the fiber optic is a single mode, multi-mode, small multi-mode or other type of fiber. The signals in each of the respective fibers are combined to obtain a single received signal. The apparatus and method further provide wavelength conversion, power adjustment, and further maintains alignment between cooperating transceivers.

### BACKGROUND OF THE INVENTION

1. Field of the Invention

The present invention relates generally to optical communication, and more specifically to free-space optical networking.

2. Discussion of the Related Art

For digital data communications, optical media offers many advantages compared to wired and RF media. Large amounts of information can be encoded into optical signals, and the optical signals are not subject to many of the interference and noise problems that adversely influence wired electrical communications and RF broadcasts. Furthermore, optical techniques are theoretically capable of encoding up to three orders of magnitude more information than can be practically encoded onto wired electrical or broadcast RF communications, thus offering the advantage of carrying much more information.

Fiber optics are the most prevalent type of conductors used to carry optical signals. An enormous amount of information can be transmitted over fiber optic conductors. A major disadvantage of fiber optic conductors, however, is that they must be physically installed.

Free-space atmospheric links have also been employed to communicate information optically. A free-space link extends in a line of sight path between the optical transmitter and the optical receiver. Free-space optical links have the advantage of not requiring a physical installation of conductors. Free-space optical links also offer the advantage of higher selectivity in eliminating sources of interference, because the optical links can be focused directly between the optical transmitters and receivers, better than RF communications, which are broadcast with far less directionality. Therefore, any adverse influences not present in this direct, line-of-sight path or link will not interfere with optical signals communicated.

Despite their advantages, optical free-space links present problems. The quality and power of the optical signal transmitted depends significantly on the atmospheric conditions existing between the optical transmitter and optical receiver at the ends of the link. Rain drops, fog, snow, smoke, dust or the like in the atmosphere will absorb, refract or scatter the optical beam, causing a reduction or attenuation in the optical power at the receiver. Indeed, one of the key issues that plagues free-space optics is fog. The length of the free-space optical link also influences the amount of power attenuation via Beers' Law, longer free-space links will naturally contain more atmospheric factors to potentially attenuate the optical beam than shorter links. Furthermore, optical beams naturally diverge as they travel greater distances. The resulting beam divergence reduces the amount of power available for detection.

Another issue that plagues free-space optics is coupling efficiency from free space into optical fiber, and more particularly, small core diameter optical fiber such as single mode fiber and small diameter multi-mode fiber. Namely, conventional systems tend to have very low efficiency when attempting to couple to these small core diameter optical fibers. As such, conventional systems typically use large diameter multimode fibers with the largest diameter receive aperture practical in order to improve coupling efficiencies.

It is with respect to these and other background information factors relevant to the field of optical communications that the present invention has evolved.

### SUMMARY OF THE INVENTION

The present invention advantageously addresses the needs above as well as other needs by providing a method of communicating optical signals over a free-space link. The method comprising the steps of: generating an optical beam having a diameter; transmitting the optical beam over a free space link to impinge on a plurality of receive objectives, wherein the diameter of the optical beam at initial transmission is greater than a sum of diameters of each of the plurality of receive objectives and spacing between the plurality receive objectives such that the optical beam overfills the plurality of receive objectives; and directing through each of the plurality of receive objectives a portion of the optical beam that impinges on each of the plurality of receive objectives directly into a respective receiver fiber optic core.

In another embodiment, the invention provides a method for optically communicating over a free space link. The method comprising: positioning a plurality of receive objectives at one end of a free space link; receiving an optical beam having a diameter that is at least 0.1 meters, is substantially constant along the free space link and is large enough to overfill the plurality of receive objectives; and each of the receive objectives directing a portion of the optical beam through the receive objective and into a respective receiver optical fiber.

In another embodiment, the invention provides an apparatus for optically communicating over free space. The apparatus, comprising: a transmit objective being configured to optically transmit a collimated optical signal having a low divergence across a free space link; the transmit objective being optically aligned across the free space link with a plurality of receive objectives that are sized and configured such that the plurality of receive objectives are overfilled by the transmitted optical signal; and each of the plurality of receive objectives being optically coupled with a respective fiber optic core, wherein the plurality of receive objectives are further configured to optically direct a portion of the transmitted optical signal directly into its respective fiber optic core.

In another embodiment, the invention provides an apparatus for optically communicating over free space. The apparatus, comprising: a first transceiver comprising a transmit objective configured to transmit a first optical signal over free space, wherein the first optical signal having a diameter of at least 10 cm when transmitted from the first transceiver and a limited divergence; and a second transceiver comprising: a) a plurality of receive objectives configured to receive the first optical signal, wherein the first optical signal has a diameter large enough to overfill at least two receive objectives; b) each of the plurality of receive objectives being optically coupled with a respective fiber optic conductor, wherein the receive objectives being configured to focus a portion of the first optical signal impinging on the receive objective into the respective fiber optic conductor; and c) a second optical signal combiner coupled with the respective fiber optic conductors, the second optical signal combiner being configured to combine the portions of the first optical signal from the respective fiber optic conductors into a first single received optical signal.

In another embodiment, the invention provides an apparatus for providing free space communication. The apparatus, comprising: a plurality of receive objectives optically aligned with a free space link, the plurality of receive objectives configured to receive an optical transmit beam directed across the free space link, wherein the plurality of receive objectives each have a diameter small enough such that the optical transmit beam overfills at least two of the receive objectives; each of the plurality of receive objectives optically couple with a respective optical fiber such that each of the plurality of receive objectives directs a portion of the optical transmit signal into its respective optical fiber; and each of the respective optical fibers being optically coupled with an optical signal combiner configured to combine the portions of the optical transmit signal directed into each of the optical fibers to form a single optical signal.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a generic receiver objective coupled to a fiber optic;

FIG. 2 depicts a free space optical communication system having an array of small transmit objectives directing an optical signal towards a receiver objective;

FIG. 3 depicts a receiver objective that is defocused to overlap a plurality of optical signals on the receiver fiber;

FIG. 4 illustrates a transmit objective optically communicating a large diameter optical signal to a receive objective over a free space link;

FIG. 5 illustrates a cross-sectional view of one implementation of one embodiment of a transmit objective;

FIG. 6 depicts a cross-sectional view of a simplified block diagram of a plurality of receiver objectives receiving a portion of large transmitter objective;

FIG. 7 depicts a simplified block diagram of a frontal view of one implementation of one embodiment of a transceiver;

FIG. 8 depicts a cross-sectional view of a simplified block diagram of one implementation of one embodiment of a communication system comprising two cooperating transceivers;

FIG. 9 illustrates a pair of free-space optical transceivers made in accordance with an embodiment of the present invention;

FIG. 10, there is illustrated an exemplary version of a transceiver made in accordance with an embodiment of the present invention that may be used in the transceivers shown in FIG. 9;

FIG. 11A depicts a flow diagram for one implementation of a method for free space optical communication;

FIG. 11B depicts a flow diagram for one implementation of a method for determining alignment of at least two transceivers performing free space optical communication;

FIG. 11C depicts a flow diagram for one implementation of a method for optimizing the free space communication; and

FIG. 11D depicts a flow diagram for one implementation of a method for determining an optimal power level of an optical data signal transmitted over a free space link.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

Previous free-space optical communication systems have attempted to employ spatial diversity in the transmitter and receiver optics in order to overcome signal interference or drop-outs from birds or other objects that may obstruct a portion of the transmitted optical beam. Spatial diversity has typically been implemented in such systems by using a large receiver aperture and/or multiple widely spaced apertures. Specifically, previous systems attempt to establish receiver spatial diversity by either utilizing a sparse array of medium-sized objective lenses or a receiver with a single large aperture objective. In these systems, a large diameter multimode fiber with a large acceptance cone (numerical aperture-NA) must be used to provide a wide field of view to allow an extended source and boresight errors in directing signals from the receiver objectives into the large core fibers. The receiver lens f/number is matched to the fiber NA through the relationship:

f/number=1/(2NA)

Previous transmitters generally utilized an array of small diameter apertures transmitting the optical signal from each small aperture to establish spatial diversity, higher power (compared with a single small aperture) and beam divergence to impinge on the receiver objective(s). Disadvantageously, this architecture creates coupling inefficiencies for small fibers (especially single mode fiber) due to the angular diversity which introduces parallax from the multiple transmitters and small field of view at the fiber receiver. Transmitter divergence and parallax between transmitter and receiver apertures create coupling inefficiencies that limit the maximum and minimum range between free-space links. Atmospheric scintillation provides a lower limit on the transmitter angular diversity and thus the field of view of a receiver.

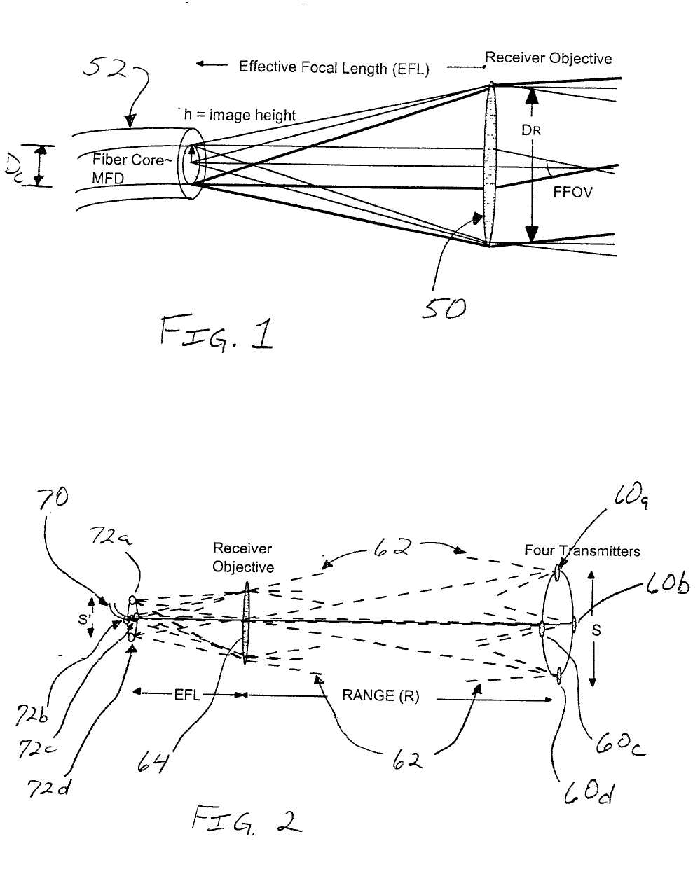

FIG. 1 depicts a generic receiver objective 50 with an entrance pupil diameter (D) and an effective focal length (EFL) coupled to a fiber optic 52 with a core diameter (Dc) and numerical aperture (NA), where:

Full Field of View (FFOV)=Dc/EFL

Because the objective f/number (where f/number=D/EFL) is matched to the fiber core NA, the only variable remaining for adjusting FFOV is the objective EFL. With conventional configurations, the FFOV is typically sized to provide the most efficient reliable coupling between the transmitters and the large core fiber possible. Factors such as boresight and scintillation affect the optimal spot size (S′) on the fiber.

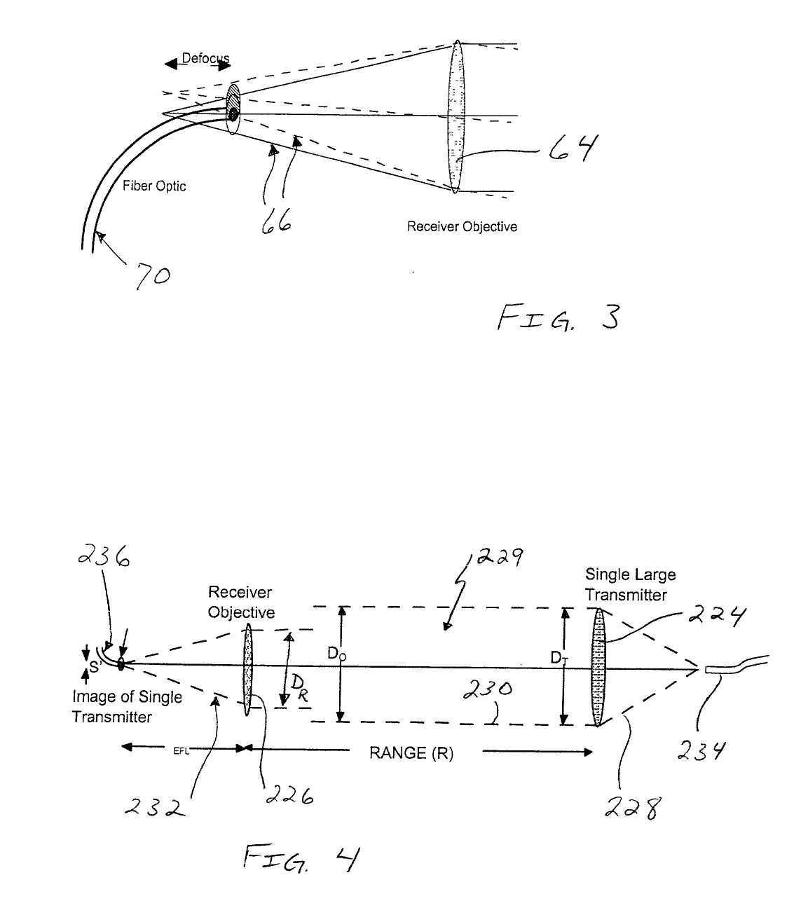

FIG. 2 depicts a free space optical communication system having an array of small transmit objectives 60a-d directing an optical signal 62a-d towards a receiver objective 64. The receiver objective directs the received optical signal 66 at the receive fiber 70. Disadvantageously, when a conventional multi-transmitter system is imaged onto a small fiber core, parallax results between the four transmitters creating an image consisting of four spots 72a-d around the fiber 70. In this configuration, only one transmitter 60 can be simultaneously aligned and focused on the fiber core. This defeats the transmitter spatial diversity or creates low coupling efficiency. Because of this low efficiency, conventional free space optical communication systems typically utilize a large diameter fiber that can potentially accept light from all the spots 72a-d simultaneously and allow the receive signal 66 to be defocused so the spots 72a-d overlap on the fiber core.

FIG. 3 depicts a receiver objective 64 that is defocused to overlap a plurality of optical signals 66 on the receiver fiber 70. The field of view is increased because the fiber can accept some light from each transmitted signal. Unfortunately, however, the coupling efficiency is low due to the large spot diameter compared with the fiber core diameter.

The use of a plurality of transmit objectives producing a plurality of transmitted signals causes additional problems including cross-talk between signals as well as errors in the data timing between the plurality of transmitted optical signals. As the speed of data transmission continues to increase to 2.5 Gbps and more, the potential for errors in data timing between signals is greatly increased. If the plurality of optical fibers supplying the transmit signals to each of the plurality of transmit objectives are unmatched by even a millimeter or two, the data transmitted can be off from other signals by as much as a bit period or more. This causes significant errors in the received signal. Therefore, the transmitters utilizing a plurality of transmit objectives require high precision path matching and high precision assembly in order to ensure the timing of the plurality of transmitted signals, resulting in increased complexity and costs.

The present invention provides a free-space optical communication system that is capable of providing high power, eye-safe operation, and both low angular diversity with high spatial diversity, in order to provide efficient coupling from a free space link into a small core diameter optical fiber, such as single mode fiber and small diameter multi-mode fiber. More specifically, the present invention provides spatial diversity and maximum power density distribution over large and small ranges by utilizing a large diameter transmitted optical data signal beam. The large diameter data signal provides spatial diversity with a data point source that is smaller or comparable to the angular field of view of a receiver. A transmitter for transmitting the large diameter data signal is configured to transmit the large diameter beam with a low divergence providing nearly equal signal levels over long (e.g., a few Kilometers) and short (e.g., a few meters) ranges, excluding atmospheric attenuation. Further, by utilizing a large diameter (and therefore, a large area) transmit beam, the present invention is capable of eyesafe transmission at increased total power levels. Additionally, the large diameter beam provides compensation for atmospheric conditions.

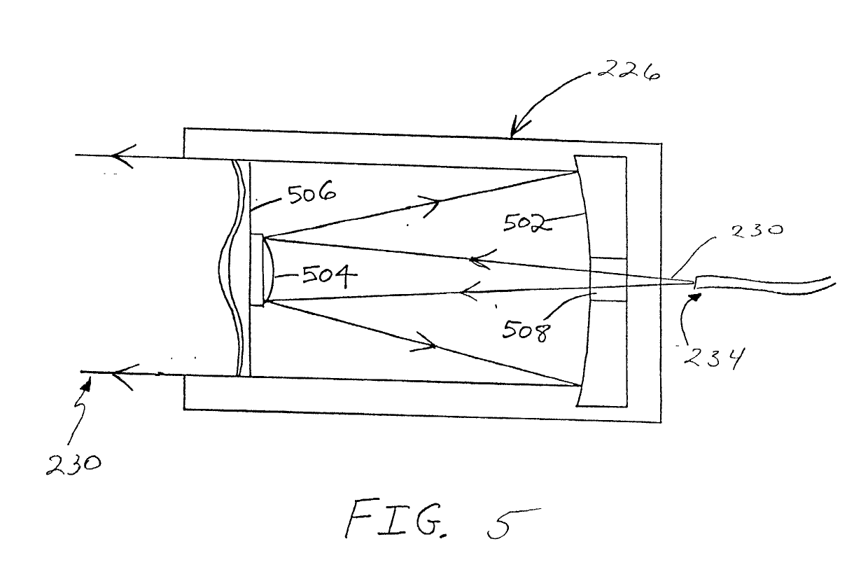

Referring to FIG. 4, there is illustrated a transmit objective 224 optically communicating a large diameter optical signal to a receive objective 226. The transmit objective 224 is configured to have a numerical aperture (NA) approximately equal to the NA of the transmit optical fiber 234. The transmit objective is positioned to receive an initial optical signal 228 from the transmit fiber optic 234 or other optical signal source (not shown), and further configured to direct an optical signal 230 with a low angular diversity towards the receive objective 226 such that at least a portion of the optical signal 230 impinges on the receive objective 226. In one embodiment, the diameter D_{T} of the transmit objective 224 is greater than the diameter D_{R} of the receive objective 226. The transmit objective transmits the substantially non-diverging optical signal 230 such that the optical signal at the receiver has a diameter D_{O} that substantially equal to the transmit objective diameter D_{T} at both short and long ranges.

A large amount of divergence of the transmitted optical signal 230 reduces the amount of received power. Typically, with increased transmitter beam divergence the loss scales are proportional to the square of beam divergence (for example, an increase in beam divergence by a factor of 3 reduces power of the received signal by a factor of about 9). In one embodiment, the transmitted optical signal 230 has a limited divergence where the divergence is less than 4 mr, preferably less than 2 mr and more preferably less than 1.5 mr. In one embodiment, the beam divergence is limited to between 0.02 to 1.0 mr of divergence. For example, a transmitted optical beam 230 with a 20 cm beam diameter at 1.55 micron wavelength is collimated to achieve a diffraction limited beam divergence of 0.02 mr.

In one embodiment, a plurality of transmit fibers 234 are optically coupled with the transmit objective, and can be utilized to each direct initial optical signals 228 at the transmit objective 224. The transmit objective 224 is configured to receive initial optical data signals 228 from any one of or a combination of the plurality of transmit fibers 234, and to generate and transmit the transmit optical signal 230 with the preferred large diameter collimated beam. The transmitted optical signal 230 is generated from any one of the plurality of transmit fibers 234 while continuing to maintain the angular non-diversity.

The transmitted signal beam diameter D_{O} at initial transmission is configured to be greater than transmitted signals in previous free space optical communication systems. The collimated transmitted beam diameter D_{O} at initial transmission is generally between 0.010 and 10 meters, which is limited by a maximum diameter for optical fabrication and a minimum practical beam size for communication systems. The transmitted beam diameter at transmission is preferably between 0.1 and 0.5 meters for commercial free space optics. This range of transmit beam diameters provides enough power for most commercial applications. In one embodiment, the diameter is determined by determining a smallest beam size that can carry sufficient laser power to communicate signals at the desired range and data rate, and impinge on a plurality of the receiver objectives of the receiver array, and preferably completely overfill the receiver array. In one embodiment, the diameter is configured to be sufficiently large to compensate for scintillation effects by providing independent and/or uncorrelated communication paths.

The transmit objective 224 is aligned with the optical free space link 229 to transmit the optical signal across the link to be received by the receive objectives, which are also aligned with the free space link 229. Because the transmitted beam diameter D_{O} is greater than the diameter D_{R} of the receive objective 226, the optical signal 230 overfills the receiver objective 226. The transmitter objective is configured through one or more optics, lenses and/or mirrors, or substantially any combination thereof which are refractive, reflective, catadioptric, diffractive and/or holographic, to provide the low divergent, large diameter optical data beam. In one embodiment, the transmit objective 224 collimates the optical signal to limit divergence of the optical signal 230 and to direct the optical signal over free space to the receive objective 226. The collimating of the optical signal 230 further results in a received power that is independent of range to the first order.

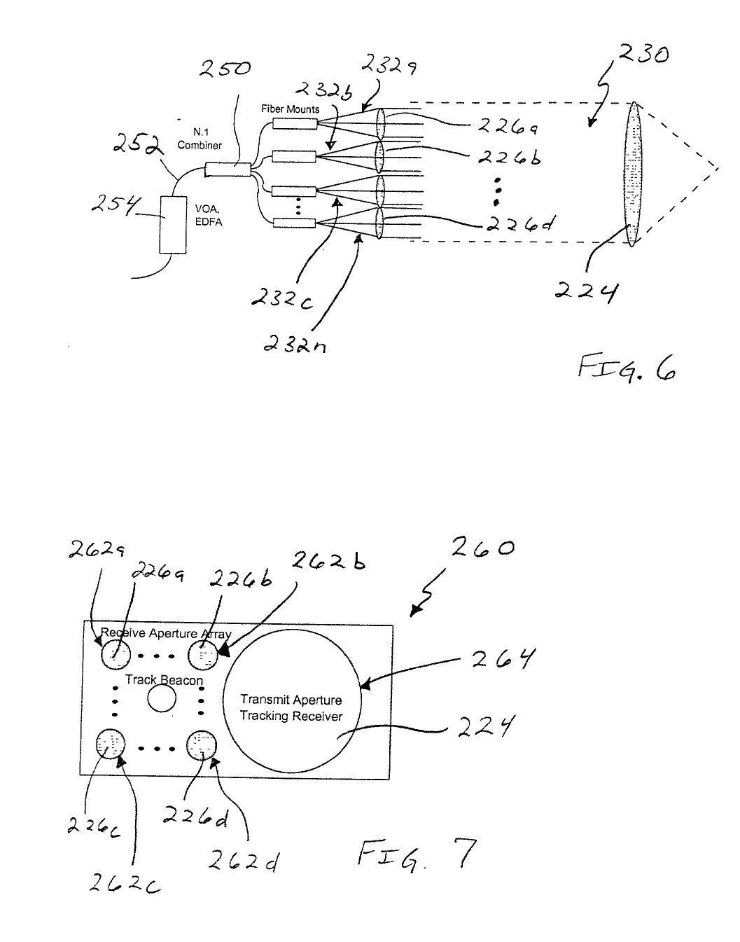

FIG. 5 illustrates a cross-sectional view of one implementation of one embodiment of a transmit objective 224. The initial optical data signal 228 is directed from one or more transmit fibers 234 through a small opening 508 in a spherical primary mirror 502 to a small primary divergence mirror 504 which reflects the transmitted optical signal in a diverging pattern towards the primary mirror 502. The primary mirror 502 reflects the signal towards a plate 506 such that the optical beam 230 is transmitted. In one embodiment, the beam 230 is collimated to limit divergence of the beam.

Referring back to FIG. 4, the receive objective 226 is configured to have a relatively short effective focal length (EFL) compared with previous free space receiver objectives. The receive objective 226 is further configured to have a NA that substantially matches the NA of the receiver optical fiber 236. The short EFL provides a relatively wide field of view on the small diameter core of the receive fiber 236 significantly reducing scintillation and boresight error effects and optimally focusing the received signal 232 into the core of the receive fiber 236. The small diameter D_{R} and short EFL allow efficient coupling of optical signals directly into the fiber core including small diameter fiber cores. Thus, the present invention optimizes the optical coupling of optical signals into substantially any size and mode fiber including single mode and multi-mode fibers (including those having core diameters less than 65 mm) and substantially any other fiber known in the art. In one embodiment, the diameter D_{R} of the receive objective 226 is configured to be less than the diameter of previous receive objectives, and smaller than the diameter of the transmit objective. Preferred receiver objectives have a diameter of less than 100 mm, preferably between 5 to 50 mm; an EFL determined by the F-number matching the fiber being optically coupled with the receive objective, where the EFL is defined by EFL=(fiber F-number)*(D_{R}). For example an F/5 single mode fiber matches a receiver objective with an EFL=100 mm for D_{R}=20 mm.

Receiving the single, oversized transmitted optical signal 230 and directing the received signal 232 directly into the core of a single fiber 232 from a single receive objective 226 prevents the parallax effects seen in previous free space optical receivers. Further, the receive objective 226 is configured to compensate for atmospheric scintillation, geometric aberration of the optics and diffraction effects to provide a spot size (s′) of the received signal 232, which is substantially equivalent to the core of the receive optical fiber 236. Therefore, the receive objective 226 focuses substantially all of the optical signal 230 impinging on the receiver objective into the core of the receive optical fiber 236.

The receiver objective 226 is configured through one or more lenses, mirrors, catadioptrics, diffractive and holographic elements, or substantially any combination of these elements. The receiver objective optics are matched to the receive fiber F/number, receive objectives diameter D_{R} is small maintaining the short EFL and the receive objective NA is matched with the NA of the receive fiber 236.

Because the transmitted optical signal 230 is over sized compared with the receiver objective 226, multiple receiver objectives can be positioned within the optical beam 230. FIG. 6 depicts a cross-sectional view of a simplified block diagram of a plurality of receiver objectives 226a-n. The plurality of receive objectives are positioned such that each receiver objective receives a portion of the optical beam 230 directed from the large transmitter objective 224 when the optical beam is unimpeded and accurately aligned. In one embodiment, the optical beam is configured to have a diameter D_{T} which is large enough to overfill at least two of the receive objectives, and preferably the optical beam diameter is large enough to overfill all of the receive objectives 226a-n. Additionally, the receive objectives are positioned in an array with spacing D_{A} between adjacent receive objectives and each receive objective is configured to have a diameters D_{R} small enough that the optical signal overfills at least two of the receive objectives 226a-n and preferably all of the receive objectives. In one embodiment, the ratio of the transmitter objective diameter D_{T} to receiver objective diameter D_{R} (i.e., D_{T}/D_{R}) is greater than two, and preferably greater than three. For example, a D_{T}/D_{R} ratio of between three and four allows an array of three or four receiver objectives 226 to fit within the single transmit beam footprint. Preferably the ratio of [D_{T}/(D_{R}+1/2D_{A})] is greater than two, and more preferably greater than three. In one embodiment, the diameter of the transmit beam D_{T} is greater than the diameter (or width and height, depending on arrangement) of the array of receiver objectives such that the substantially non-diverging transmit beam overfills each of the receive objectives in the array.

Each receive objective 226a-n directs a corresponding received optical signal 232a-n directly into the core of a respective receive optical fiber 236a-n. Advantageously, the multiple receiver objectives do not introduce parallax because each receiver objective 226a-n is boresighted at infinity and focuses the received signal 232a-n directly into its respective receive optical fiber core 236a-n. Utilizing a plurality of relatively small receive objectives allows the optimization of the angular diversity of the received signal independent of the optimization of the low angular diversity of the transmit objective. Additionally, the plurality of received objectives allows spacing of the receive objectives to provide a high spatial diversity. Each receiver objective 226a-n is preferably configured to have a relatively short EFL and to have an NA that substantially matches the NA of the corresponding receiver optical fiber 236a-n. The short EFL of each receive objective provides the relatively wide field of view on the small diameter core of the receive fibers 236a-n, which significantly reduces boresight error and scintillation effects and optimally directs the received signals 232a-n into the core of the corresponding receive fibers 236a-n. As one example, the receive objectives are an arrays of 2×2 lenses, having diameters of between 10 and 50 mm, with an EFL of between 50 and 250 mm to match a F/5 single mode fiber.

In one embodiment, the present invention isolates the transmit objective from the receive objectives to provide a bi-static system. Utilizing the bi-static system allows the present invention to optimize the transmitter to gain the low angular diversity independent of the receive objectives, and allows the receiver to be optimized for low angular diversity. Additionally, the bi-static system further allows the optimization of the spatial diversity while still achieving low angular diversity.

Still referring to FIG. 6, in one embodiment, the signals received in the plurality of respective optical fibers 236a-n are combined through an optical combiner 250 to produce a single receive optical signal directed from the combiner 250 into a fiber optic line 252. Additionally, the single received optical signal 232 can be further processed with passive or active photonic components, such as Erbium doped fiber amplifiers (EDFA) and variable optical attenuators (VOA), labeled in FIG. 6 as 254. The optical combiner 250 is configured to combine the signals without electro-optical conversion, however, it will be apparent to one skilled in the art that the signals could also be combined utilizing electro-optical conversion.

As was discussed above, the relatively small receive objectives 226a-n optimize the signal coupling directly into the core of the receive fibers 236a-n. Additionally, the small diameters D_{R} of the receivers are such that a plurality of receiver objectives can be positioned within a single, large diameter Do, transmitted optical signal 230. The plurality of receive objectives 226a-n provide spatial diversity without introducing parallax. Further, the system 220 maintains angular non-diversity because the transmitted optical signal 230 is transmitted from the single, large transmitter objective 224.

In one embodiment, the receive objective full field of view (FFOV) is matched to the angular scintillation of the atmosphere, i.e., between approximately 0.005 to 0.5 mr, and preferably between approximately 0.01 to 0.3 mr, depending on the varying local conditions. For example, a receiver objective having an EFL of 100 mm and an F-number of 5 provides a 0.1 mr FFOV on a 10-micron single mode receiver optical fiber.

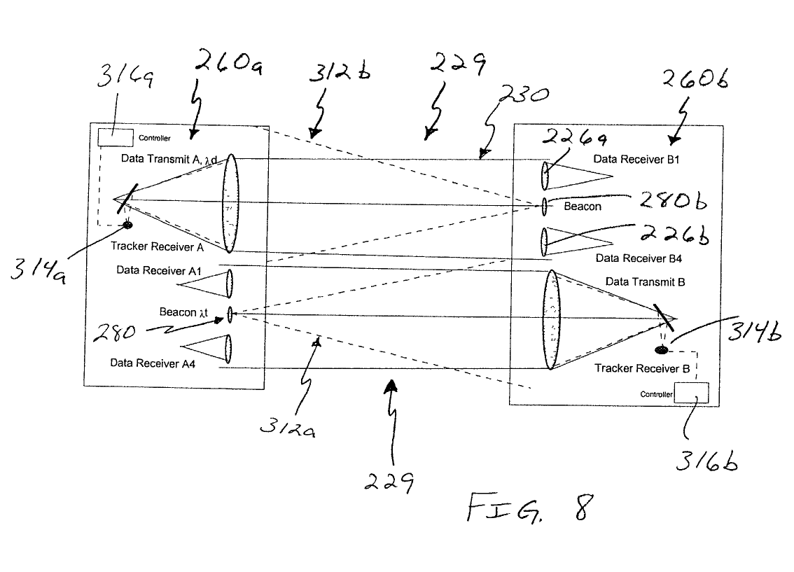

FIG. 7 depicts a simplified block diagram of a frontal view of one implementation of one embodiment of a transceiver 260 for transmitting and receiving optical signals over free space. The transceiver includes an array of receive apertures 262a-n within which receive objectives 226a-d are secured, and a transmit aperture 264 within which a transmit objective 224 is secured. For simplicity, the transceiver 260 is shown with an array of four receive apertures 262a-d and objectives 226a-d, however, it will be clear to one skilled in the art that any number of receive apertures and objectives can be included in the transceiver. The transceiver 260 is configured to cooperate with one or more additional transceiver to establish a free space optical link for optically transmitting signals over free space between the cooperating transceivers.

In one embodiment, the receive apertures 262a-d are positioned such that the transmitted optical signal 230 from a cooperating transceiver impinges on 100% of each of the receive apertures 262a-d. The transmit signal, as one example, has a diameter D_{O} of at least two times the receive objective diameter D_{R} to allow the transmit signal to impinge 100% of at least two receive objectives positioned adjacent one another. Further, the receive apertures are sufficiently spaced to provide adequate spatial diversity to the free space communication system 220 employing one or more transceivers 260. The spatial diversity compensates for interference of the transmitted optical signal 230 to one or more of the receive apertures. The spatial diversity aids in ensuring that one or more of the receive apertures 262a-d will receive at least a portion of the transmitted signal 230, even if the transmitted signal experiences interference, such as, if a bird or other object passing through the optical signal blocking a portion of the transmit signal, scintillation effects, and other conditions interfering with the transmitted signal 230.

Still referring to FIG. 7, in one embodiment, the transceiver 260 further includes a tracking system that allows the transceiver to maintain optical communication with the one or cooperating transceivers. The transceiver includes a tracking beacon 280. The tracking beacon 280 can utilize the transmitted optical signal 230 or an alternate tracking beacon to determine changes in the alignment between cooperating transceivers 260 to maintain boresight between the cooperating transceivers.

The transceiver can be configured to include a plurality of tracking beacons 280 to provide greater spatial diversity. In one embodiment, a spatially redundant, alternate tracking signal is utilized to increase beacon reliability and link margin. The plurality of beacons are included within the transceiver 260 such that a tracking signal is transmitted from a plurality of beacons to reduce the risk that all the beacons will be disrupted (i.e., by a bird or small interfering object) while simultaneously allowing more output power to be used to maintain a proper link margin. The tracking transmit and receive beacon(s) can be integrated with the optical data signal transmitter 224 transmitting the optical data signal 230, or implemented through optics independent of the data signal transmitter. If an independent tracking beam is generated, the beam can be configured to be divergent for robust tracking. For example, the tracking beam may diverge between 0.1 and 20 mr, preferably between 0.1 to 10 mr and more preferably between 0.5 and 6 mr depending on the expected mount stability. Because the tracking beacon does not require the sensitivity that the data receiver objectives require, in particular for data rates higher than 155 Mbps, the large divergence of the tracking beam does not adversely affect the reception of the tracking beam. The independent tracking beam can also be generated utilizing a different wavelength (λt) than the data optical signal to avoid beacon/data cross-talk. The tracking beam can further be generated with a different modulation, such as a different amplitude modulation, to further avoid beacon/data cross-talk.

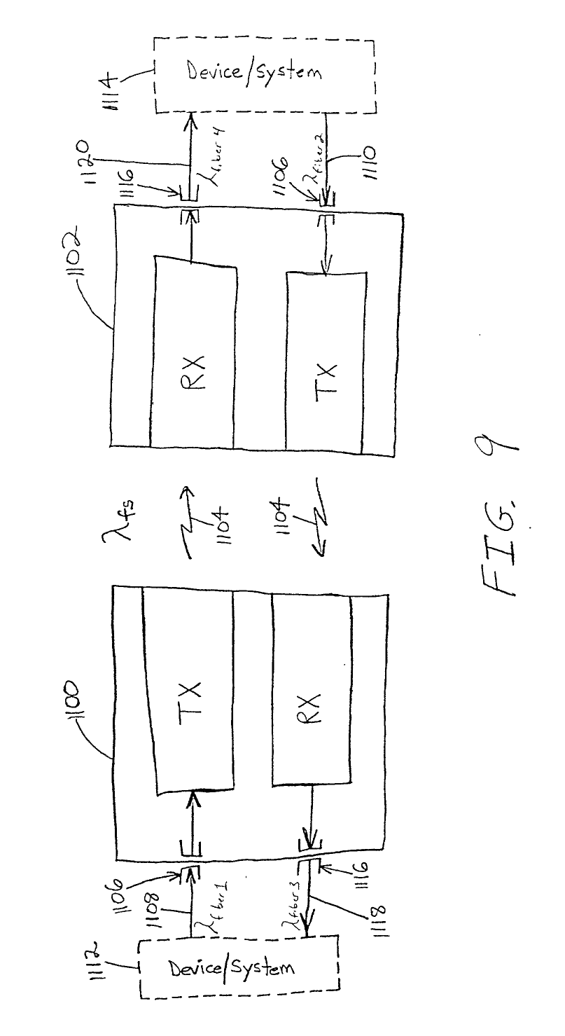

FIG. 8 depicts a cross-sectional view of a simplified block diagrams of one implementation of one embodiment of a free space communication system comprising two cooperating transceivers 260a-b. The first transceiver 260a is optically aligned with the free space link 229 and transmits the collimated transmit data signal 230a. The second transceiver 260b is also aligned with the free space link and receives the transmit signal 230a with a plurality of receive objectives 226a-b. The second transceiver 260b further includes a beacon 280b aligned with the free space link. The beacon 260b transmits a beacon or tracking signal 312b across the free space link 229. The first transceiver 260a receives the tracking signal 312b and directs the received tracking signal to one or more sensors 314a. In one embodiment, the sensors are incorporated as part of the beacon. The sensor 314a generates a resultant tracking signal which is forwarded to a controller 316a. The controller 316a determines the directional location and boresight of the communication path between the first and second transceivers 260a-b based on the tracking signal 312b received by the sensor 314a and maintains alignment with the free space link 229. The controller 316a is configured to determine shifts and/or changes in the free space link and to signal the first and/or second transceivers 260a-b to adjust or reposition to compensate for the shifts or changes in the free space link. The controllers 316a and 316b, and the control of the transceivers 260 to maintain an optimal communication path are further described in co-pending U.S. patent applications, Ser. Nos. 09/849,613 and 09/864,093, entitled TERRESTRIAL OPTICAL COMMUNICATION NETWORK OF INTEGRATED FIBER AND FREE-SPACE LINKS WHICH REQUIRES NO ELECTRO-OPTICAL CONVERSION BETWEEN LINKS (Atty. Doc. No. 70646) and FREE-SPACE OPTICAL COMMUNICATION SYSTEM EMPLOYING WAVELENGTH CONVERSION (Atty. Doc. No. 70651), respectively, the entire contents of both are hereby fully incorporated into the present application by reference, but this is not required.

Still referring to FIG. 8, the first transceiver 260a further includes a beacon 280a that transmits a tracking signal 312a. The second transceiver includes one or more sensors 314b for receiving the tracking signal 312a. The sensor couples with a controller 316b that implements adjustments in the first and/or second transceivers 260a-b to compensate for shifts and changes in the free space link 229 based on the information received from the sensor 314b.

The sensors 314 are implemented through substantially any optical receiver, such as one or more photodiodes, a quad cell, CCD array and substantially any other optical receiver known in the art. In one embodiment the beacons 280 and/or sensors 314, along with other components of the transceiver, are mounted on a gimbal mount (not shown). The beacon 280 and the gimbal mount slew the transceiver 260, and only one beacon is required to ensure alignment between transceivers 260a-b. In one embodiment, light received through a beacon 280 is directed through a filter (not shown) and field stop (not shown), and impinges on a quad position sensor 314, which is used for sensing beam position. By way of example, the quad position sensor 314 may comprise a 3-80 mr full field of view (FFOV), 850 nm sensor.

Utilizing one or more beacons within the transceiver allows control of the transceiver to be steered by a single tracking device eliminating the need to track the transmitters and receivers separately. Furthermore, the present invention uses several techniques to maintain alignment and an optimum amount of power is available in the free-space links despite the presence of atmospheric attenuating conditions. Those techniques include adaptive power control to control the received and transmitted power levels at the transceivers to account for and overcome attenuating atmospheric conditions, and beam tracking to physically move the transceivers into better positions to receive the optical beam.

In one embodiment, the adaptive power control technique and the tracking technique of the present invention are, again based in part on the recognition that the transceivers in optical communication transmit the optical signals through the same atmospheric media. The free space link between both transceivers exhibits substantially the same attenuation characteristics, regardless of the direction of propagation of the optical signal. Power control is accomplished at each transceiver, based on a comparison of the received signal strength to an optimum signal strength that has previously been established for that free space link. If the received signal strength is less than the optimum value, a power controller, in one embodiment power controller is incorporated within controller 316, monitoring the power level increases the amplifying power of the transmitting beam based on the assumption that the receiving transceiver is likewise receiving a lower than optimum amount of power in its received optical signals. In one embodiment, the amplification is obtained through an erbium doped fiber amplifier (ERFA). The controller may likewise increase the amplifying power of the EDFA to boost the optical power of the signal(s) that is delivered after receipt. If the received signal strength is greater than the optimum value, a variable optical attenuator (VOA) controller decreases the power from the transmitting EDFAs, again based on the same assumption. A similar adaptation of the power control at the other transceiver occurs, until both transceivers have established the optimum power levels for the atmospheric conditions through the free-space link that connects them.

Referring to FIG. 9, there is illustrated a pair of free-space optical transceivers 1100, 1102 made in accordance with an embodiment of the present invention. The transceivers 1100, 1102 are ideal for communicating data over a free-space optical link 1104 and can do so through substantially all weather conditions, including rain, snow, heat and in particular fog.

In the illustrated embodiment, each of the transceivers 1100, 1102 includes a transmit portion TX having the large diameter transmit objective (not shown) for transmitting the large diameter optical data signal and receive portion RX having the plurality of small diameter receive objectives (not shown) for focusing the received signal directly into the small diameter core of the receive fiber. Each transmit portion TX includes a connector 1106 or the like for connecting directly to a fiber optic conductor, which comprises substantially any fiber optic cable including single mode, multi-mode and small single-mode fiber, and preferable single mode fiber optic cable. The transmit fiber optic cable connecting to transceiver 1100 is designated by 1108, and the transmit fiber optic cable connecting to transceiver 1102 is designated by 1110. The transmit fiber optic cables 1108, 1110 operate at fiber interface wavelengths λ_{fiber1} and λ_{fiber2}, respectively, where wavelengths λ_{fiber1} and λ_{fiber2} can be the same wavelength or different wavelengths. The cables 1108, 1110 may be coupled to external devices and/or systems 1112, 1114, for example a long-haul fiber optic terrestrial communication network or system(s). By way of example, the fiber interface wavelengths λ_{fiber1}, λ_{fiber2} may be equal to a 1550 nanometer (nm) fundamental wavelength, a 1310 nm fundamental wavelength, or other wavelengths.

Similarly, each receive portion RX of the transceivers 1100, 1102 includes a connector 1116 or the like for connecting directly to a fiber optic conductor, such as a single mode, multi-mode or other fiber optic cable. The receive fiber optic cable connecting to transceiver 1100 is designated by 1118, and the receive fiber optic cable connecting to transceiver 1102 is designated by 1120. The fiber optic conductors 1118, 1120 operate at fiber interface wavelengths λ_{fiber3}, λ_{fiber4}, respectively, which can be equal or different wavelengths and can further be equal to or different than the λ_{fiber1}, λ_{fiber2} wavelengths. Similar to the fiber optic cables 1108, 1110, the fiber optic cables 1118, 1120 may be coupled to external devices and/or systems 1112, 1114, which may comprise a long-haul fiber optic communication system(s). In one embodiment, a controller (not shown) is provided within each transmit and receive portion TX, RX to achieve the optimum interface power specification for the devices and/or systems 1112, 1114 connected to the connectors 1106, 1116. The controllers can further be configured to control the tracking between transceivers 1100 and 1102 to maintain the boresight.

In accordance with the present invention, the transceivers 1100, 1102 are capable of interfacing with their respective fiber optic conductors at the fiber interface wavelengths λ_{fiber1-4}, and then conducting free-space optical communications at a preferred free-space transformed wavelength λ_{free-space}, or simply λ_{fs}, that is optimal for penetrating the current weather conditions such as fog and the like. In order to perform this function, the transceivers 1100, 1102 perform a wavelength conversion from the fiber interface wavelengths λ_{fiber1-2} to the preferred free-space transformed wavelength λ_{fs}, and then back again to the fiber wavelengths λ_{fiber3-4}. For example, the transmit portion TX of each of the transceivers 1100, 1102 is configured to convert the wavelength of an optical signal from λ_{fiber1-2} to λ_{fs} and direct the optical signal over the free-space link 1104. The receiver portion RX of each of the transceivers 1100, 1102 is configured to receive the optical signal and reproduce exactly the same data signal at the desired interface wavelength by converting the wavelength of the optical signal from λ_{fs} to λ_{fiber3-4}. Thus, the transceivers 1100, 1102 direct optical signals that originate from optical fibers through a free-space link using appropriate wavelengths to overcome the atmospheric conditions, both man-made and natural.

As used herein, the term “fundamental wavelength” and the variables λ_{fiber1-4}, λ_{free-space}, and λ_{fs} are intended to include a wavelength band having multiple wavelengths around the indicated fundamental wavelength that will be treated as a contiguous spectrum for amplification and conversion.

In one embodiment, wavelength conversion from fiber interface wavelength λ_{fiber1-2} to a preferred transformed wavelength λ_{fs} and pulse shaping is performed to overcome a broad range of environmental impacts to the free-space optical signal. The transformed wavelength to be propagated between optical transceivers through the atmosphere is chosen specifically to overcome a plurality of conditions that could degrade the optical beam, used for optical communications. By way of example, a preferred transformed wavelength λ_{fs} having a value in the midwave infra red (MWIR) range, such as 3.5 um, has been found to be ideal for overcoming certain densities of fog. It should be well understood, however, that the preferred transformed wavelength λ_{fs} may comprise many different values in accordance with the present invention, and may be time varying according to a dynamic wavelength selection control methods of the present invention. Thus, by conducting free-space optical communications at the preferred transformed wavelength λ_{fs} that is optimal for penetrating fog and the like, the transceivers 1100, 1102 provide an all weather free-space optics communication system.

In accordance with some embodiments of the present invention, the wavelength conversions (transformations) performed by the transceivers 1100, 1102 are performed all-optically without the need for electro-optical conversion. Because no electro-optical conversion takes place in these embodiments of the transceivers 1100, 1102, they may be referred to as “all-optical transceivers,” or an “all-optical system,” or performing the wavelength conversions “all-optically.” By performing the wavelength transformation all-optically, these embodiments of the present invention avoid problematic and costly electro-optical conversion.

In one embodiment, the transceivers 1100, 1102 further communicate to indicate the free space wavelength, power levels and alignment shifts being utilized to transmit, or to indicate when one transceiver changes or shifts to an alternate free space wavelength. The communication between transceivers can be achieved through the established free space link utilizing their respective large transmit objectives and small diameter receive objectives. Alternatively, the communication can be achieved through one or more alternative communication paths such as an alternative free space link utilizing alternative transmit and receive objectives, or through substantially any other wired or wireless communication including, direct wiring, phone lines, cellular communication, radio frequency (RF) communication and substantially any other means known in the art for communicating between distal components, such as transceivers. In one embodiment, the cooperating transceivers can further communicate with a central control unit (not shown) that provides system control for at least the cooperating transceivers, and preferably a plurality of cooperating transceivers. The communication between transceivers can be utilized to communicate numerous different conditions and modes of each transceiver.

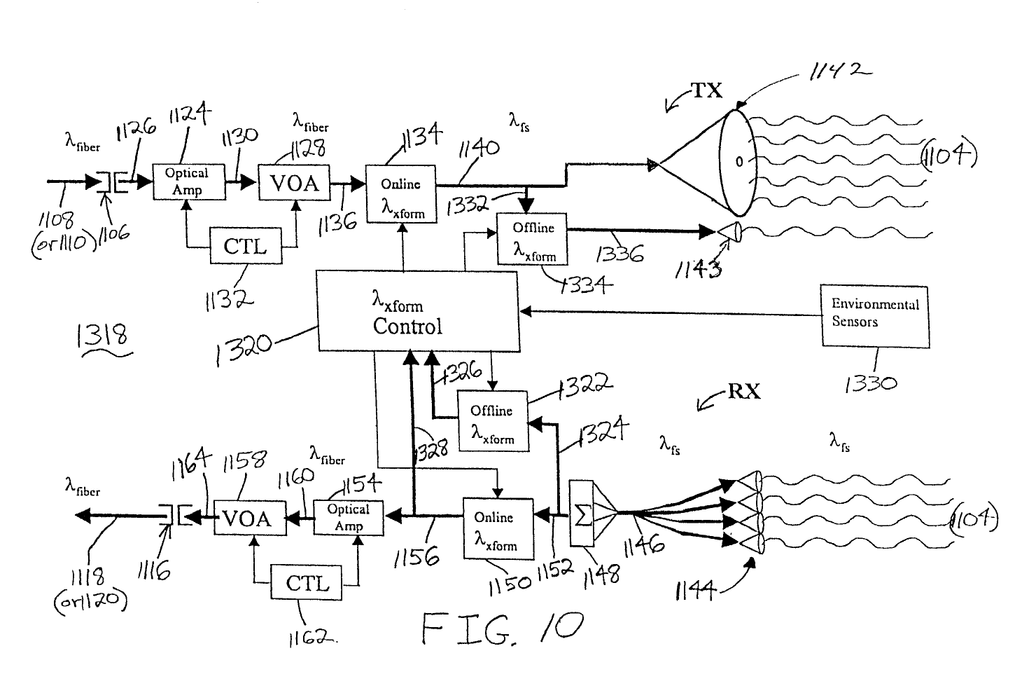

Referring to FIG. 10, there is illustrated an exemplary version of a transceiver 1318, which may be similar to transceivers 260a-b, 1100 and 1102, where transceiver 1318 includes transmit and receive portions TX, RX, respectively, made in accordance with an embodiment of the present invention. Regarding the transmit portion TX, in this version the connector 1106 is coupled with a multi-wavelength optical (or fiber) amplifier 1124 via a fiber optic cable 1126. One example of a multi-wavelength optical amplifier that may be used in the present invention is an erbium doped fiber amplifier (EDFA). It should be well understood, however, that the multi-wavelength optical amplifier 1124 may comprise any type of optical (or fiber) amplifier that can support multiple wavelengths.

The multi-wavelength optical amplifier 1124 is coupled to a variable optical attenuator (VOA) 1128 via a fiber optic cable 1130. The VOA 1128 smoothes and/or provides dampening to the power gain of the multi-wavelength optical amplifier 1124. The VOA 1128, which for example may have a dynamic range of 30-40 dB, includes an electrical interface that is controlled by a controller 1132. The controller 1132 includes logic that is used to intelligently control the VOA 1128 according to the system demands. Pursuant to this intelligent control scheme, the controller 1132 communicates the desired level of attenuation to the VOA 1128. Thus, the controller 1132 controls the power gain of the multi-wavelength optical amplifier 1124 and the dynamic attenuation provided by the VOA 1128 to achieve the required interface power specification for the externally connected devices and/or systems 1112, 1114 (FIG. 9) and to overcome amplitude variations due to scintillation.

By way of example, the intelligent gain control provided by the controller 1132 may be based on the measured power of, or control information included in, optical signals received over the free-space link 1104, but this is not required. By way of further example, the intelligent control provided by the controller 1132 may utilize, or be similar to, the adaptive power control techniques described in U.S. Pat. No. 6,239,888, filed Apr. 24, 1998, entitled TERRESTRIAL OPTICAL COMMUNICATION NETWORK OF INTEGRATED FIBER AND FREE-SPACE LINKS WHICH REQUIRES NO ELECTRO-OPTICAL CONVERSION BETWEEN LINKS, by inventor Heinz Willebrand, the entire contents of which are hereby fully incorporated into the present application by reference, but again this is not required.

The VOA 1128 is coupled to a wavelength transformer (or converter) 1134 via a fiber optic cable 1136. The wavelength transformer 1134, the operation of which will be described below, is coupled with at least one large diameter transmitting objective or element 1142, which directs the optical data over the free-space link 1104.

The receive portion RX includes one or more small diameter receiving objectives or elements 1144, as compared with the transmit element, which receive the large diameter optical data beam from the free-space link 1104. Each receiving element 1144 is coupled to a fiber optic 1146 followed by a fiber combiner 1148. The fiber combiner 1148 is coupled to a wavelength transformer (or converter) 1150 via a fiber optic cable 1152. The wavelength transformer 1150 is coupled with a multi-wavelength optical (or fiber) amplifier 1154 via a fiber optic cable 1156. It should be well understood that the multi-wavelength optical amplifier 1154 may comprise any type of optical (or fiber) amplifier that can support multiple wavelengths. An EDFA is one example of such multi-wavelength optical amplifier.

The multi-wavelength optical amplifier 1154 is coupled to a VOA 1158 via a fiber optic cable 1160. Similar to the VOA 1128, the VOA 1158 smoothes and/or provides dampening to the power gain of the multi-wavelength optical amplifier 1154. The VOA 1158 and the multi-wavelength optical amplifier 1154 are controlled by a controller 1162 that includes logic that is used to intelligently control the devices according to the system demands. As mentioned above, such intelligent control may be based on the measured power of, or control information included in, optical signals received over the free-space link 1104, including the data signal, a beacon/tracking signal or other control signals.

The VOA 1158 is coupled with the connector 1116 via a fiber optic cable 1164. With respect to the devices and/or systems 1112, 1114 connected to the connectors 1116, the controllers 1162 control the power gain of the multi-wavelength optical amplifier 1154 and the attenuation provided by the VOA 1158 to achieve the required interface power specification for such externally connected devices and/or systems.

During operation, the transmit portion TX receives an initial optical signal from the fiber optic cable 1108 (or 1110). The wavelength of this optical signal is equal to the fiber interface wavelength λ_{fiber}. The optical amplifier 1124 is preferably capable of amplifying any fiber interface wavelength λ_{fiber} prior to sending the signal to the wavelength transformer 1134. The optical amplifier 1124 may also shorten the output pulse length to create ultrafast pulses. The wavelength transformer 1134 converts the wavelength λ_{fiber} to the preferred transformed wavelength λ_{fs}. The beam diameter is enlarged through substantially any means known in the art including diverging the beam to the desired diameter, then collimating the beam and transmitting the beam at the new wavelength by the transmit portion TX over the free-space optical link 1104 to the receive portion RX. The signal, still at the preferred transformed wavelength λ_{fs}, is collected by the one or more receiving elements 1144 of the receive portion RX and then recombined single optical signal at the free space wavelength λ_{fs}. The wavelength transformer 1150 converts the free-space optical wavelength λ_{fs} to the fiber interface wavelength λ_{fiber}. The converted optical signal is then further conditioned by the receive portion RX before being produced at the output connector 1116. The signal produced at the output connector 1116 is the original data signal having the fiber interface wavelength λ_{fiber}, which may also contain a plurality of wavelengths as coarse wavelength division multiplexing (CWDM) or dense wavelength division multiplexing (DWDM).

The receive portion RX design includes unique optical concentrators that function for various wavelengths that are broadband in nature. Specifically, each transmitted wavelength spectrum that is sent through the atmosphere may contain one or more wavelengths that are up and down-converted to the desired optical couplers and amplifiers designed for a given wavelength. For example, λ_{fiber} may actually represent several (e.g. four) distinct wavelengths that are multiplexed into the fiber and that are centered, for example, at or near 1550 nm. Similarly, λ_{fs} may actually represent several distinct wavelengths that are multiplexed and that are centered, for example, at or near 3800 nm. Thus, the wavelength transformers 1134, 1150 preferably comprise wavelength conversion devices that are capable of handling large numbers of wavelengths multiplexed together during both the up-conversion and down-conversion process. In particular, both single wavelength and multiple wavelengths are capable of being transformed, including CWDM and DWDM. The wavelength transformers 1134, 1150 preferably include narrowband filters that are wide enough to pass DWDM signals.

In one embodiment, the present invention provides the ability to monitor the performance of a chosen value for the preferred transformed free space wavelength λ_{fs}, and using a feedback control system, dynamically adjust the value for the free space wavelength λ_{fs} until the optimum value for the given atmospheric conditions is achieved. The value for the preferred transformed wavelength λ_{fs} is preferably adjusted by a configurable wavelength transform controller 1320 that is coupled to and controls the online wavelength transformers 1134, 1150. The online wavelength transformers 1134, 1150 may comprise all-optical devices, such as nonlinear optics, or perform the wavelength conversions using electro-optical conversion.

The configurable wavelength transform controller 1320 preferably performs an adaptive approach to wavelength selection in which an offline sampling algorithm is set to constantly, periodically or in response to a signal or alarm, find the best absorption wavelength and power through the atmosphere. The transform controller 1320 signals the offline wavelength transformer 1334 to generate an offline signal at a wavelength different from that of the data signal. The offline signal is transmitted through the large diameter transmitter objective 1142, or alternatively through a separate transmit objective 1143. The receiver RX receives the offline signal and directs the offline signal to the transform controller 1320. The transform controller determines whether the offline signal performance exceeds the online signal performance. If the offline performance exceeds the online performance, for example by some threshold, then the offline configurable parameters are programmed into the configurable online wavelength transformers 1134, 1150 to change the wavelength to the more optimal wavelength and take advantage of the better performance gleaned from the offline wavelength.

Configurable offline wavelength transformer 1322 in the receive path and configurable offline wavelength transformer 1334 in the transmit path are used by the controller 1320 to determine the offline performance. A sample of the transmitted optical signal is provided to the offline wavelength transformer 1334, and a sample of the received optical signal is provided to the offline wavelength transformer 1322. The wavelength converted optical signal from the offline wavelength transformer 1322 is supplied to the controller 1320, and a sample of the wavelength converted optical signal from the online wavelength transformer 1150 is supplied to the controller 1320. Furthermore, one or more environmental sensors 1330 may be co-located in the transceiver or located externally at any distance. The environmental sensors 1330 interface to the controller 1320 and are used to determine and select the best wavelength for the given atmospheric conditions.

A method and system for performing wavelength conversion that may be used by the present invention is described more fully in co-pending U.S. patent application Ser. No. 09/864,093, filed May 21, 2001 entitled FREE-SPACE OPTICAL COMMUNICATION SYSTEM EMPLOYING WAVELENGTH CONVERSION, (Atty. Doc. No. 70651), the full contests of which are incorporated herein by reference.

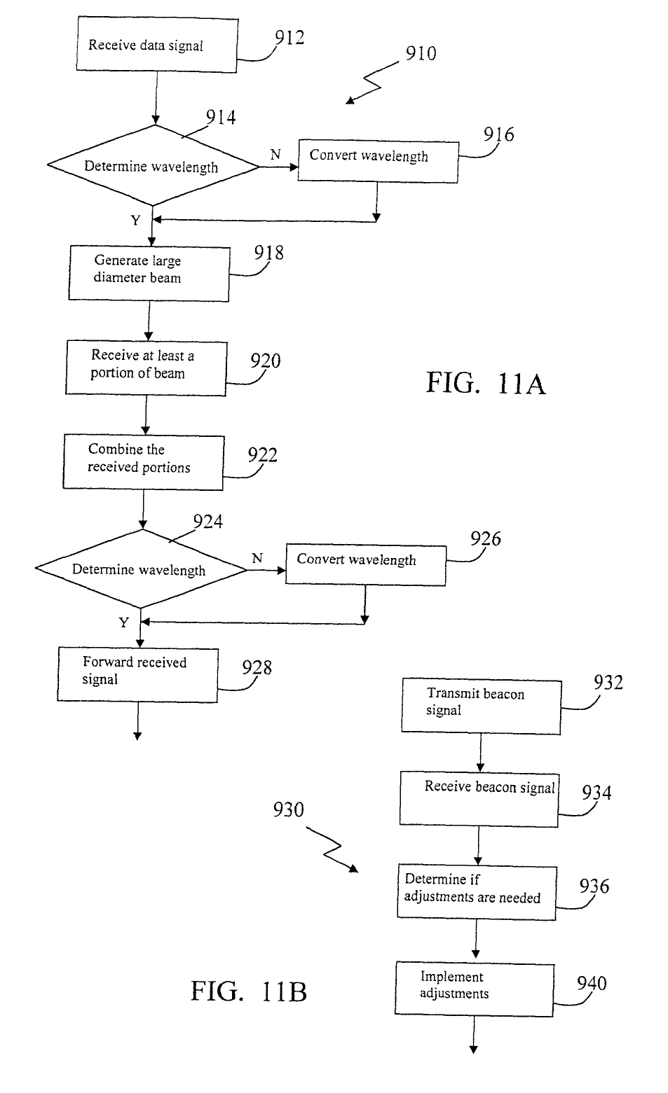

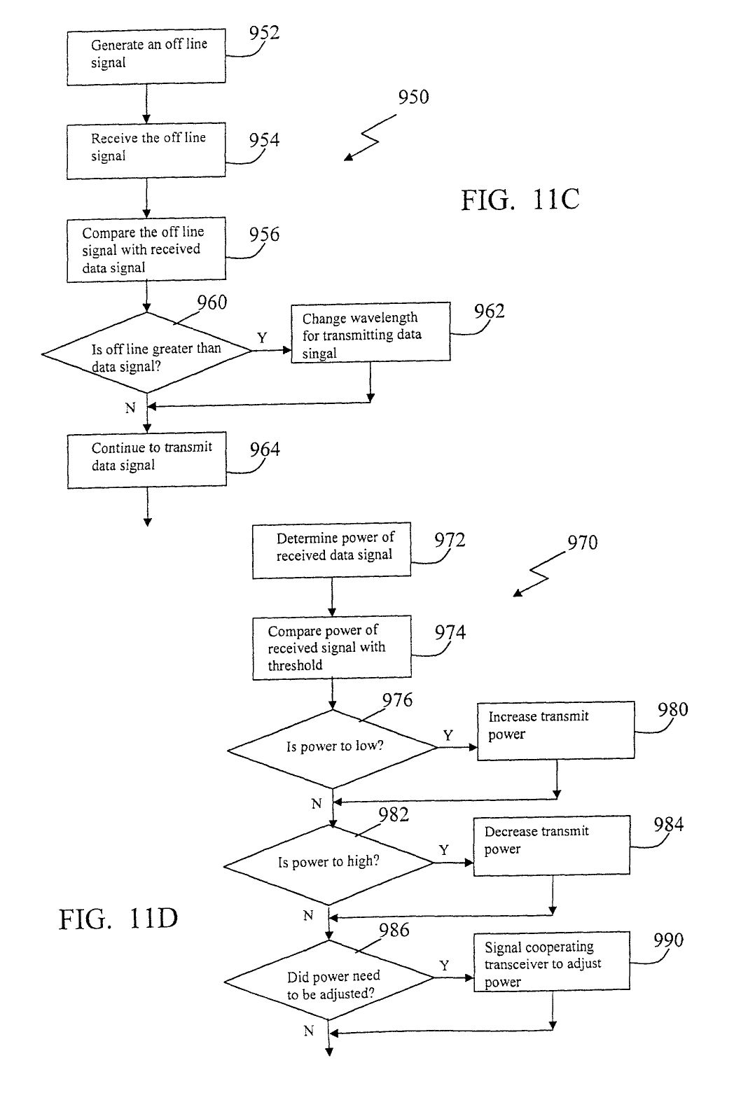

FIG. 11A depicts a flow diagram for one implementation of a method 910 for free space optical communication. In step 912, an initial optical signal is delivered to a first transceiver from an optical fiber or other optical signal source. In step 914 it is determined if the wavelength λ_{fiber} of the optical signal corresponds to a desired free space wavelength λ_{fs}. If the wavelength λ_{fiber} is not a desired free space transmission wavelength λ_{fs}, step 916 is entered where the wavelength of the signal is converter to the desired wavelength λ_{fs}. In step 918 a large diameter D_{O} optical data beam 320 is generated having the desired free space wavelength and is directed across free space towards a second transceiver. In step 920 the second transceiver receives the data signal beam through a plurality of receive objectives. In step 922, the portions of the transmitted beam received from each of the plurality of receive objectives are combined into a single received signal. In step 924, it is determined if the wavelength λ_{fs} of the single received signal is an optimal wavelength to be further transmitted to other components or fiber cable. If the wavelength λ_{fs} is not a desired fiber transmission wavelength λ_{fiber}, step 926 is entered where the wavelength of the signal is converted to the desired fiber wavelength λ_{fiber}. In step 928, the data signal is forwarded to other components or fiber cable.

FIG. 11B depicts a flow diagram for one implementation of a method 930 for determining alignment of at least two transceivers performing free space optical communication. In step 932, a first transceiver generates a beacon signal that is transmitted over free space and generally directed towards a second transceiver. In step 934, the second transceiver receives the beacon signal. In step 936, the second transceiver determines if adjustments are needed to optimize alignment and maintain boresight with the first transceiver. In step 940, the controller implements the adjustments to maintain alignment.

FIG. 11C depicts a flow diagram for one implementation of a method 950 for optimizing the free space communication. In step 952, a first transceiver generates an optical off line signal that is different than an optical data signal also generated by the first transceiver. The off line signal is generated at a wavelength λ_{fs}_{_{—}}ₒₗ which is different than the wavelength λ_{fs}_{_{—}}_{d} of the data signal. In step 954, a second transceiver receives the off line signal. In step 956, a comparison is made between the free space transmission performance of the received off line signal and the received data signal. By way of example, such performance may be measured by detecting the optical power, receive bit error rate, signal to noise ratio, and other such factors in determining the performance of each signal. In step 960, it is determined if the performance of the data signal is greater than the performance of the off line signal. If the performance of the off line signal is greater than that of the data signal, step 962 is entered where the first transceiver alters the transmission wavelength λ_{fs}_{_{—}}_{d} to more closely match the wavelength λ_{fs}_{_{—}}ₒₗ of the off line signal. If the data signal performance is greater than the off line signal, then step 964 is entered where the first transceiver continues to transmit the data signal without changes to the wavelength λ_{fs}_{_{—}}_{d}.

FIG. 11D depicts a flow diagram for one implementation of a method 970 for determining an optimal power level of an optical data signal transmitted over a free space link. In step 972, the optical data signal is received by a first transceiver. In step 974, the power level of the received data signal is determined and compared with a threshold power level. In step 976, it is determined if the power level of the received data signal is less than the threshold level. If the power level is less than the threshold, step 980 is entered where the first transceiver increases the power level of data signals transmitted by the first transceiver over the free space link. In step 982 it is determined if the power level of the received data signal is greater than the threshold level. If the power level is greater than the threshold, step 984 is entered where the first transceiver decreases the power level of data signals transmitted by the first transceiver over the free space link. In step 986, the first transceiver notifies a second transceiver in communication with the first transceiver of changes made in the power level. In step 990 the second transceiver initiates similar changes in the power levels of optical data signals transmitted by the second transceiver.

The subject invention provides greater free space optical communication efficiency by improving optical signal coupling from free space directly into the core of substantially any type of optical fiber, including single mode, multi-mode, small multi-mode and substantially any other optical fiber. The improved efficiency is achieved, at least in part, by the precision obtained in utilizing small receiver objectives with shorter focal lengths for directing the optical signal directly into the fiber core.

The use of the large diameter transmit beam provides spatial diversity by coupling the transmit beam onto a plurality of small receiver objectives while avoiding the use of a plurality of transmit beams. Utilizing the single large diameter transmit beam also avoids cross-talk seen in previous free-space optical communication systems due to the transmission of a plurality of transmit signals in an attempt to obtain spatial diversity. The large diameter transmit beam allows for the transmission of the beam at greater power levels. The single large transmit beam further avoids the complexity, cost and precision required by previous systems for path matching, and avoids data transmission latencies as is seen in previous systems transmitting a plurality of beams, because only a single fiber is needed to deliver the optical data signal to the transmit objective. The large transmit beam allows for low angular diversity while still providing high spatial diversity. The single large beam avoids the introduction of parallax. Additionally, directing the large transmitted beam at a plurality of receivers reduces scintillation effects by providing a plurality of decorrelated paths of communication when the transmitted beam is configured large enough to provide uncorrelated paths. The present invention additionally reduces scintillation effects by optimizing angular diversity, spatial diversity, and both angular and spatial diversity. Thus, the subject invention provides high transmission efficiency.

Utilizing a plurality of small diameter receiver objectives allows coupling of the optical signal transmitted across the free space link directly into single mode fibers to provide high spatial diversity with a large field of view. In one embodiment, the coupling of the optical signal into the fiber is preformed all optically without the need for electro-optical conversion. However, electro-optical conversion can be utilized. The fiber coupling can handle large numbers of wavelengths multiplexed together.

While the invention herein disclosed has been described by means of specific embodiments and applications thereof, numerous modifications and variations could be made thereto by those skilled in the art without departing from the scope of the invention set forth in the claims.

What is claimed is:

1. A method of communicating optical signals over a free space link, comprising the steps of:
generating an optical beam having a diameter;
transmitting the optical beam over a free space link to impinge on a plurality of receive objectives, wherein the diameter of the optical beam at initial transmission is greater than a sum of diameters of each of the plurality of receive objectives and spacing between the plurality receive objectives such that the optical beam overfills the plurality of receive objectives; and
directing through each of the plurality of receive objectives a portion of the optical beam that impinges on each of the plurality of receive objectives directly into a respective receiver fiber optic core.

2. The method as claimed in claim 1, wherein:
the step of generating the optical beam including collimating the optical beam and limiting the divergence of the optical beam such that the optical beam is substantially non-divergent and has a diameter at transmission of at least 0.1 meters.

3. The method as claimed in claim 2, wherein:
the step of limiting the divergence of the optical beam including limiting the divergence of the optical beam to less than 0.1 mr.

4. The method as claimed in claim 2, further comprising the step of:
combining the portions of optical beam from each of the respective receiver fiber optic cores into a single optical signal.

5. The method as claimed in claim 4, wherein:
performing the steps of transmitting the optical beam, directing the portion of the optical beam and combining the portions of the optical beam all optically and without electro-optical conversion.

6. The method as claimed in claim 4, wherein:
at least one of the respective receiver fiber optic cores is a single mode fiber optic.

7. The method as claimed in claim 4, wherein:
at least one of the respective receiver fiber optic cores is a multi-mode fiber optic having a core diameter less than 100 micrometers.

8. The method as claimed in claim 1, wherein the diameter of the optical beam at transmission is equal to or greater than 0.1 meters.

9. The method as claimed in claim 8, wherein diameters of each of the plurality of receive objectives are between 5 and 100 millimeters.

10. The method as claimed in claim 1, wherein the step of generating the optical beam including generating a plurality of decorrelated optical paths.

11. The method as claimed in claim 1, further comprising the step of:
providing low the angular diversity; and
providing high spatial diversity.

12. The method as claimed in claim 1, further comprising the steps of:
receiving an initial optical signal having a first wavelength;
converting the wavelength of the initial signal to a second wavelength prior to the step of generating the optical beam; and
the step of generating the optical beam including generating the optical beam from the initial signal having the second wavelength.

13. The method as claimed in claim 12, further comprising the step of:
combining the portions of optical beam from each of the respective receiver fiber optic cores into a single optical signal, wherein the single optical signal has a wavelength equal to the second wavelength; and
converting the wavelength of the single optical signal to a third wavelength.

14. The method as claimed in claim 12, wherein:
performing the steps of receiving the optical beam, converting the first wavelength, transmitting the optical beam, and directing the portion of the optical beam all optically.

15. The method as claimed in claim 1, further comprising:
receiving an initial optical signal;
optically adjusting the power of the initial optical signal; and
the step of generating the optical beam including generating the optical beam from the adjusted optical signal.

16. The method as claimed in claim 15, further comprising the step of:
combining the portions of optical beam from each of the respective receiver fiber optic cores into a single optical signal;
monitoring the power of the single optical signal; and
performing the step of optically adjusting the power of the optical beam if the power of the optical signal is less than a threshold level.

17. A method of communicating optical signals over a free space link, comprising the steps of:
positioning a plurality of receive objectives at one end of a free space link;
receiving an optical beam having a diameter that is at least 0.1 meters, is substantially constant along the free space link and is large enough to overfill the plurality of receive objectives; and
each of the receive objectives directing a portion of the optical beam through the receive objective and into a respective receiver optical fiber.

18. The method as claimed in claim 17, wherein:
the optical beam having a divergence of less than 1.0 mr.

19. The method as claimed in claim 17, wherein:
the respective optical fibers comprise single mode optical fibers.

20. The method as claimed in claim 17, wherein:
the respective optical fibers comprise multi-mode optical fibers having a core diameter less than 100 micrometers.

21. The method as claimed in claim 17, further comprising the step of:
optically combining the portions of optical beam from each of the respective fiber optic cores into a single optical signal.

22. The method as claimed in claim 21, further comprising the step of:
optically coupling the single optical signal into a fiber optic link of a terrestrial optical communication network.

23. An apparatus for optically communicating over free space, comprising:
a transmit objective being configured to optically transmit a collimated optical signal having a low divergence across a free space link;
the transmit objective being optically aligned across the free space link with a plurality of receive objectives that are sized and configured such that the plurality of receive objectives are overfilled by the transmitted optical signal; and
each of the plurality of receive objectives being optically coupled with a respective fiber optic core, wherein the plurality of receive objectives are further configured to optically direct a portion of the transmitted optical signal directly into its respective fiber optic core.

24. The apparatus as claimed in claim 23, wherein:
the transmit objective being configured to optically transmit the collimated optical signal having a divergence of less than 1.5 mr across the free space link.

25. The apparatus as claimed in claim 23, wherein:
each of the receive objectives have an effective focal length of less than 300 mm.

26. The apparatus as claimed in claim 23, wherein:
the transmit objective has a diameter sufficiently large to generate the optical signal with a diameter at transmission that is at least 0.1 meters.

27. The apparatus as claimed in claim 26, wherein:
the transmitted optical signal is configured to have a substantially constant diameter across the free space link.

28. The apparatus as claimed in claim 27, further comprising:
each of the respective fiber optics being optically coupled with an optical combiner configured to combine the optical signal from each of the fiber optics to generate a single optical signal.

29. The apparatus as claimed in claim 23, further comprising:
a plurality of transmit optical fibers being optically coupled with the transmit objective, wherein each of the plurality of transmit optical fibers being configured to direct an initial optical signal at the transmit objective such that the transmitted optical signal is based on at least one of the initial optical signals.

30. An apparatus for optically communicating over free space, comprising:
a first transceiver comprising a transmit objective configured to transmit a first optical signal over free space, wherein the first optical signal having a diameter of at least 10 cm when transmitted from the first transceiver and a limited divergence; and
a second transceiver comprising:
a) a plurality of receive objectives configured to receive the first optical signal, wherein the first optical signal has a diameter large enough to overfill at least two receive objectives;
b) each of the plurality of receive objectives being optically coupled with a respective fiber optic conductor, wherein the receive objectives being configured to focus a portion of the first optical signal impinging on the receive objective into the respective fiber optic conductor; and
c) a second optical signal combiner coupled with the respective fiber optic conductors, the second optical signal combiner being configured to combine the portions of the first optical signal from the respective fiber optic conductors into a first single received optical signal.

31. The apparatus as claimed in claim 28, wherein:
the first transceiver being configured to optically transmit the first optical signal having a divergence of less than 1.0 mr.

32. The apparatus as claimed in claim 29, wherein:
the plurality of receiver objectives have effective focal lengths less than 300 mm.

33. The apparatus as claimed in claim 30, wherein:
the first optical signal is configured to overfill all of the plurality of receive objectives.

34. The apparatus as claimed in claim 30, further comprising:
the second transceiver further comprising a transmit objective configured to transmit a second optical signal having substantially no divergence over the free space; and
the first transceiver further comprising:
a) a plurality of receive objectives configured to receive the second optical signal, wherein the second optical has a diameter large enough to overfill at least two receive objectives of the first transceiver;
b) each of the plurality of receive objectives of the first transceiver being optically coupled with a respective fiber optic conductor, wherein the receive objectives of the first transceiver being configured to focus a portion of the second optical signal impinging on the receive objective into the respective fiber optic conductor; and
c) the respective fiber optic conductors being coupled with a first optical signal combiner configured to combine the portions of the second optical signal from the respective fiber optic conductors into a second single received optical signal.

35. The apparatus as claimed in claim 34, further comprising:
the second transceiver further comprising a second beacon configured to receive the first optical signal; and
the second beacon being coupled with a power controller configured to determine a power of the first optical signal and to adjust a power level of the second optical signal based on the power of the first optical signal.

36. The apparatus as claimed in claim 30, further comprising:
the second transceiver further comprising a second beacon configured to receive the first optical signal and to sense the position of the first transceiver; and
the second beacon being coupled with a second controller configured to receive position information from the beacon and to maintain optical alignment between the first and second transceivers based on the position information.

37. The apparatus as claimed in claim 30, further comprising:
the first transceiver further comprising a first beacon configured to transmit a tracking signal over the free space;
the second transceiver further comprising a second beacon configured to receive the tracking signal and to sense the position of the first transceiver based on the received tracking signal; and
the second beacon being coupled with a second controller configured to receive position information from the second beacon and to maintain optical alignment between the first and second transceivers based on the position information.

38. The apparatus as claimed in claim 30, further comprising:
the first optical signal have a first wavelength; and
the second transceiver further comprising a second wavelength transformer coupled with the second optical signal combiner, the second wavelength transformer being configured to optically transform the first single received optical signal to a second wavelength.

39. The apparatus as claimed in claim 38, further comprising:
a transmit optical conductor being coupled with the first transceiver, and configured to supply an initial optical signal having a third wavelength; and
the first transceiver further comprising a first optical wavelength transformer configured to receive the initial optical signal and to optically transform the third wavelength to the first wavelength prior to the first transceiver transmitting the first optical signal.

40. The apparatus as claimed in claim 30, further comprising:
the second transceiver further comprising a second beacon configured to receive the first optical signal; and
the second beacon being coupled with a power controller configured to determine a power of the first optical signal and to signal the first transceiver to adjust the power level of the first optical signal.

41. The apparatus as claimed in claim 30, further comprising:
the second transceiver being coupled with a terrestrial optical communication network, wherein the second transceiver optically couples the first single received optical signal into a fiber optic link of the terrestrial optical communication network.
